(19) United States
(12) Patent Application Publication
(10) Pub. No.: US 2024/0121447 A1
(43) Pub. Date: Apr. 11, 2024

(54) SYSTEMS, APPARATUS, AND METHODS FOR BIT LEVEL REPRESENTATION FOR DATA PROCESSING AND ANALYTICS

(71) Applicant: Board of Regents, The University of Texas System, Austin, TX (US)

(72) Inventors: RICHARD E. S. LISTER METZLER, CASTLE HILLS, TX (US); SOS S. AGAIAN, SAN ANTONIO, TX (US)

(73) Assignee: Board of Regents, The University of Texas System, Austin, TX (US)

(21) Appl. No.: 18/379,746

(22) Filed: Oct. 13, 2023

Related U.S. Application Data
(63) Continuation of application No. 15/552,843, filed on Aug. 23, 2017, now abandoned.
(60) Provisional application No. 62/119,444, filed on Feb. 23, 2015.

(51) Int. Cl. H04N 19/91; G06N 20/00; H04N 19/11; H04N 19/14; H04N 19/61

(52) U.S. Cl. CPC H04N 19/91; G06N 20/00; H04N 19/11; H04N 19/14; H04N 19/61

(57) ABSTRACT

Systems, apparatuses, and methods provide various progressive, bit-level representations of digital data that are useful for a variety of systems and applications within the fields of machine learning, signal and data processing, and data analytics. Systems, apparatus, and methods for such representations incorporate one or more systems for machine learning, predicting, compressing and decompressing data, and are progressive such that the representations embody a sequential organization of information that prioritizes more information over less significant information. Embodiments of the present disclosure include systems for denoising, enhancing, compressing, decompressing, storing, and transmitting digitized media such as text, audio, image, and video. Methods can include partitioning data, modeling partitioned data, predicting partitioned data, transforming partitioned data, analyzing partitioned data, organizing partitioned data, and partially or fully restructuring the original data. Some embodiments of the present disclosure can include representations that combine both spatial and (or) color data in digital imagery into progressive sequences of information.

### CROSS REFERENCE TO RELATED APPLICATIONS

This application is a continuation application claiming priority to, and the benefit of, U.S. Non-Provisional application Ser. No. 15/552,843, filed Aug. 23, 2017, which is the 35 U.S.C. § 371 national stage application of PCT Application No. PCT/US2016/018887, filed Feb. 22, 2016, where the PCT Application claims priority to, and the benefit of, United States Provisional Application No. 62/119,444, entitled “SYSTEMS, APPARATUS, AND METHODS FOR BIT LEVEL REPRESENTATION FOR DATA PROCESSING AND ANALYTICS,” and filed on Feb. 23, 2015, all of which are hereby incorporated by reference as if set forth herein in their entireties.

### BACKGROUND

The abilities of modern networked devices and sensors to acquire data and initiate transactions of that data across widespread networks using Web-based services has led to proliferation in the amount of digital data that must be managed. In addition, the prevalence of “big data” is growing beyond large, scientific data sets to include high quality audio media, visual media, and databases that combine numerous instances of multiple sets of data in an organized structure. For example, large databases that require expedient access from Web-based services might consist of one or more combinations of personal data, social data, inventory data, financial data, and transaction records among many others.

### BRIEF DESCRIPTION OF THE DRAWINGS

Various examples of the principles of the present disclosure are illustrated in the following drawings. The drawings are not necessarily to scale. The drawings and detailed description thereto are not intended to limit the disclosure to the particular forms disclosed. To the contrary, the drawings are intended to illustrate the principals applicable to all modifications, equivalents, and alternatives falling within the spirit and scope of the present disclosure.

FIG. 1 is a depiction of possible sampling schemes used in image compression on the Lena image. a) Samples of individual data from a time varying sequence. b) Samples of pairwise data from a time varying sequence. c) Samples of individual pixels forming image data. d) Samples of 8×8 regions of pixels forming image data.

FIG. 2 depicts a visualization of a transformed image into a sparse transform domain on the Lena image. a) The original image; b) Samples consisting of 8×8 spatial partitions of pixel data; c) Sample coefficients after image transformation by the discrete cosine transform (DCT); d) An alternate organization of the coefficients.

FIG. 3 depicts a visualization of a lossy compression scheme on the Lena image. This is a 4×, lossy compression of a grayscale image achieved by removing the least significant DCT transform coefficients.

FIG. 4 depicts a visualization of a lossless compression scheme. This is a lossless compression of a repetitive sequence using a variable order Markov model (VMM) to learn from previously processed samples and predict probability distributions over values of subsequent samples with which an entropy encoder can transform the original sequence into a shorter sequence without loss of information.

FIG. 5 depicts a visualization of an image compression scheme on the Lena image.

FIG. 6 illustrates a graphical depiction of trees representing variable order Markov models (VMMs) used in some instances of the present disclosure.

FIG. 7 depicts a representation of nodes found within VMM tree graphs used in some examples of the present disclosure. Type 1 nodes model a single variable type and predict values corresponding to their child nodes. Type 2 nodes correspond to values of different variable types but predict values of a single variable type that does not correspond to any of the nodes.

FIG. 8 depicts a possible hierarchical Markov forest (HMF) used in various instances of the present disclosure. Each Type 2 tree contains node variables and values that predict a single variable of interest's value. The variable of interest are arranged in hierarchical order, from left to right.

FIG. 9 depicts another possible hierarchical Markov forest (HMF) used in various instances of the present disclosure. This illustration depicts an HMF as a Bayesian Network with links between variables selected by VMMs.

FIG. 10 depicts examples of various Markov Blankets selectable by a VMM according to some examples of the present disclosure. A Markov Blanket Rⱼ is a set of variables that are each Markov related to a single variable xⱼ, that when connected together graphically form a Bayesian Network. One can use Markov methods for predicting value of variable xⱼ from the joint information provided by the Markov Blanket variables. In our implementation, a VMM models which variables are available for forming the blanket and predicting xⱼ.

FIG. 11 depicts an example of embedded contexts within a VMM. A list of the active contexts after a VMM has processed the sequence abracadabrabracadabra. Notice that each, higher-order context is embedded in the lower-order ones, in that it is a partition of the count distributions of the lower-order count distributions.

FIG. 12 is a depiction of two possible ECF schemes used in various examples of the present disclosure.

FIG. 13 depicts a graph of informational compaction of RGB data using different transforms. This graph plots the distribution of entropy between three KLT and three, composite HMF coefficients representing the color channel information in the Lena image. The HMF transformation is the most informationally compact and provides both a smaller average informational description of the image and a greater informational sparsity as measured by the Gini coefficient.

FIG. 14 depicts a graph of informational compaction of spatial data using different transforms. This graph plots the distribution of entropy between 64 KLT and 64 aggregate HMF coefficients representing 8×8 pixel blocks in the grayscale Lena image. The HMF transformation is the most informationally compact and provides both a smaller average informational description of the image and a greater informational sparsity as measured by the Gini coefficient.

FIG. 15 illustrates a visualization of a wavelet transform and constituent quadtree on the Lena image. Three levels of complementary high-pass/ low-pass filtering using biorthogonal 2,2 wavelets results in a multiresolution structure. Coefficients representing the same region of the original image are contained within quadtree structures, as depicted by the boxed coefficients for a single quadtree.

FIG. 16 illustrates a visualization of a quadtree structure.

FIG. 17 illustrates a scanned version of the Lena reference image in grayscale.

FIG. 18 is an illustration of a wavelet or HMF denoised version of the scanned Lena reference image provided in FIG. 17.

FIG. 19 is an illustration of a wavelet or HMF enhanced version of the denoised Lena reference image provided in FIG. 17.

FIG. 20 is an illustration of a wavelet or HMF superresolution version of the scanned Lena reference image provided in FIG. 17.

FIG. 21 is a diagram of a compressive transformation method used in various instances of the present disclosure. A compressive transformation combines permutation, modelling, prediction, and encoding of sample in such a way that the output is (on average) a compressed representation of the sample.

FIG. 22 is a diagram of an inverse compressive transformation system used in some examples of the present disclosure.

FIG. 23 is a diagram depicting a training of a model for compressive transformation. Models for compressive transformation are constructed at least partially based on measured correlations between the contents (e.g. random variables) of training samples, from which a prioritized organization of the contents can also be determined.

FIG. 24 is diagram of a compressive transformation system that utilizes an HMF model in some instances of the present disclosure.

FIG. 25 is a diagram of an inverse compressive transformation system that utilizes an HMF in some examples of the present disclosure.

FIG. 26 is a diagram depicting the training of an HMF model for compressive transformation in some instances of the present disclosure. A general HMF model construction diagram. Here, mutual information and conditional information are measures of correlation, and the priority measure is given by their total difference over all variables. Finally, the HMF is constructed from VMMs trained on each variable type in hierarchical sequence based on their respective priority measures.

FIG. 27 is a diagram of a signal denoising system using compressive transformations in some examples of the present disclosure. Truncation or guided replacement of compressed transform coefficients followed by inverse transformation can result in a denoised signal. We call a randomized, guided replacement or alteration of coefficient bits a generative decoding or a generative denoising process.

FIG. 28 is a diagram of a signal enhancement system using compressive transformations in various instances of the present disclosure. Randomized or guided alteration of compressed transform coefficients followed by inverse transformation can result in an enhanced signal. We call a randomized, guided alteration of coefficient bits a generative decoding or a generative enhancement process.

FIG. 29 is a diagram of a signal superresolution system using compressive transformations in some instances of the present disclosure. Randomized or guided alteration of compressed transform coefficients followed by inverse transformation can result in an enhanced signal. We call a randomized, guided alteration of coefficient bits a generative decoding or a generative enhancement process.

FIG. 30 is a diagram of a lossy signal compression system using compressive transformations in some examples of the present disclosure. A general lossy compression system using a compressive transformation truncations the compressed representation and directly (or generatively) decodes the truncated representation for an approximate reconstruction.

FIG. 31 is a diagram of a lossy image compression system using compressive transformations in various examples of the present disclosure. The addition of forward and inverse wavelet transforms and a multiscale compressive transformation learning and transformation to the general compression system of FIG. 30 can result in a powerful lossy image compression and decompression system.

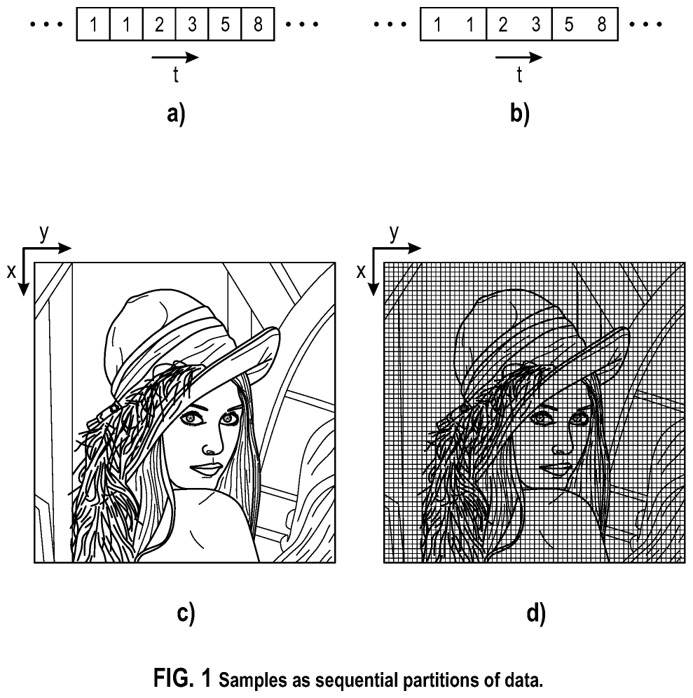

### SUMMARY

Disclosed are various embodiments of a system for bit level representation for data processing and analytics. The system can include a computing device comprising a processor and a memory; and an application stored in the memory that, when executed by the processor, causes the computing device to at least: compute likeness measures between discrete samples of data; order data according to a priority value based at least in part on a portion of the likeness measures; construct one or more models based at least in part on a portion of the likeness measures and at least a portion of the ordered data; and transform, according to at least a portion of at least one of the models, samples of data into a progressive, binary representation comprising sets of single-bit coefficients. In some instances of the system, a portion of the samples of date are transformed into the progressive, binary representation using a compression system. In some instances of the system, the compression system uses a prediction about at least one partition of the samples of data to cause the computing device to transform the samples of data into the progressive, binary representation. In some instances of the system, at least one of the sets of single-bit coefficients comprises a set of block transform coefficients. In some instances of the system, at least one of the sets of single-bit coefficients comprises a multiresolution transform coefficient.

Disclosed are various embodiments of a method for bit level representation for data processing and analytics. The method can include computing, via a computing device, likeness measures between discrete samples of data; ordering, via the computing device, data according to a priority value based at least in part on a portion of the likeness measures; constructing, via the computing device, one or more models based at least in part on a portion of the likeness measures and at least a portion of the ordered data; and transforming, via a computing device, samples of data into a progressive, binary representation comprising sets of single-bit coefficients, wherein the transforming occurs according to at least a portion of at least one of the models. In some instances of the method, a portion of the samples of date are transformed into the progressive, binary representation using a compression system. In some instances of the method, the compression system uses a prediction about at least one partition of the samples of data to cause the computing device to transform the samples of data into the progressive, binary representation. In some instances of the method, at least one of the sets of single-bit coefficients comprises a set of block transform coefficients. In some instances of the method, at least one of the sets of single-bit coefficients comprises a multiresolution transform coefficient.

Disclosed are various embodiments of a non-transitory computer readable medium comprising a program for bit level representation for data processing and analytics. The program can, when executed by a processor of a computing device, cause the computing device to at least: compute likeness measures between discrete samples of data; order data according to a priority value based at least in part on a portion of the likeness measures; construct one or more models based at least in part on a portion of the likeness measures and at least a portion of the ordered data; and transform, according to at least a portion of at least one of the models, samples of data into a progressive, binary representation comprising sets of single-bit coefficients. In some instances, a portion of the samples of date are transformed into the progressive, binary representation using a compression system. In some instances, the compression system uses a prediction about at least one partition of the samples of data to cause the computing device to transform the samples of data into the progressive, binary representation. In some instances, at least one of the sets of single-bit coefficients comprises a set of block transform coefficients. In some instances, at least one of the sets of single-bit coefficients comprises a multiresolution transform coefficient.

### DETAILED DESCRIPTION

It is to be understood that the present disclosure is not limited to particular devices, systems, or methods, which may, of course, vary. It is also to be understood that the terminology used herein is for the purpose of describing particular embodiments only. As used in this specification and the appended claims, the singular forms “a,” “an,” and “the” include singular and plural referents unless the content clearly dictates otherwise. The term “include,” and derivations thereof, mean “including, but not limited to.” The term “coupled” means directly or indirectly connected. The terms “block” or “set” mean a collection of data regardless of size or shape. The term “block” can also refer to one of a sequence of partitions of data. The term “coefficient” can include a singular element from a block of data.

Embodiments herein relate to automated quantitative analysis and implementation of a data representation and compressions scheme as they apply to digital media. In addition, embodiments herein relate to modeling, arranging, predicting, and encoding digital data such that the final representation of the data requires fewer bits than a previous representation. Accordingly, the present disclosure relates to computational systems, methods, and apparatuses for projecting image data into sparser domains, specifically the here-defined informationally sparse domains. However, the methods are applicable to digital signals and data in general and not to digital images alone. One can define informational sparsity as the relative compaction of the informational bits (or other symbols) in any perfectly decodable representation of a signal. Further, a “compressive transform” can refer to any invertible transform that maps an input signal into an informationally sparse representation, as further discussed within. To measure informational sparsity between distributions of transform coefficients, one can utilize the Gini Coefficient (also known as the Gini index or Gini ratio) from which a computational system can grade the compaction properties of a transform.

The Gini Coefficient measures the disproportionality between an observed distribution of a set positive numbers and a uniform distribution over the same set. A uniform distribution is the least sparse distribution with a Gini coefficient equal to 0, and a distribution that has a single, non-zero value is the sparsest with Gini Coefficient equal to 1. Mathematically, for a distribution X of k discrete values x, one can define the Gini Coefficient G as follows:

$$G = \frac{( k + 1 - 2 \times \frac{{\sum }_{i = 0}^{k - 1} ( k - i ) {x}_{i}}{{\sum }_{j = 0}^{k - 1} {x}_{j}} )}{k - 1} \qquad ( 1 )$$

where i indexes the values in the set in ascending order from 0 to k−1. To determine the informational compaction performance of a compressive transform over a set of samples indexed by a time step t , one can measure the empirical entropy of each coefficient type over the samples and calculate the sparsity as the Gini Coefficient of the set of coefficient entropies. For example, provided a set of samples C(t) of transformed coefficients cᵢ(t), one can measure the informational sparsity of the transformation as the Gini Coefficient of the set:

H_{C}={H_{c}_{₀}, H_{c}_{₁}, . . . , H_{c}_{_{k−1}}} (2)

where H_{c}_{ᵢ} is the empirical entropy of the distribution of sample coefficients cᵢ(t) and empirical entropy is defined as:

$${H}_{{c}_{i}} = \frac{1}{n} {\sum }_{t = 0}^{n - 1} - log ( {p}_{{c}_{i}} ( t ) )$$

where p_{c}_{ᵢ}(t) is the probability of observing the value of coefficient c, at time step t. In instances where the Gini coefficient is not the only measure of informational sparsity, the Gini coefficient can employ a measure of sparsity (such as those based upon Lₐ norm—where a is a positive integer) that fits the intended application of a sparsifying transform.

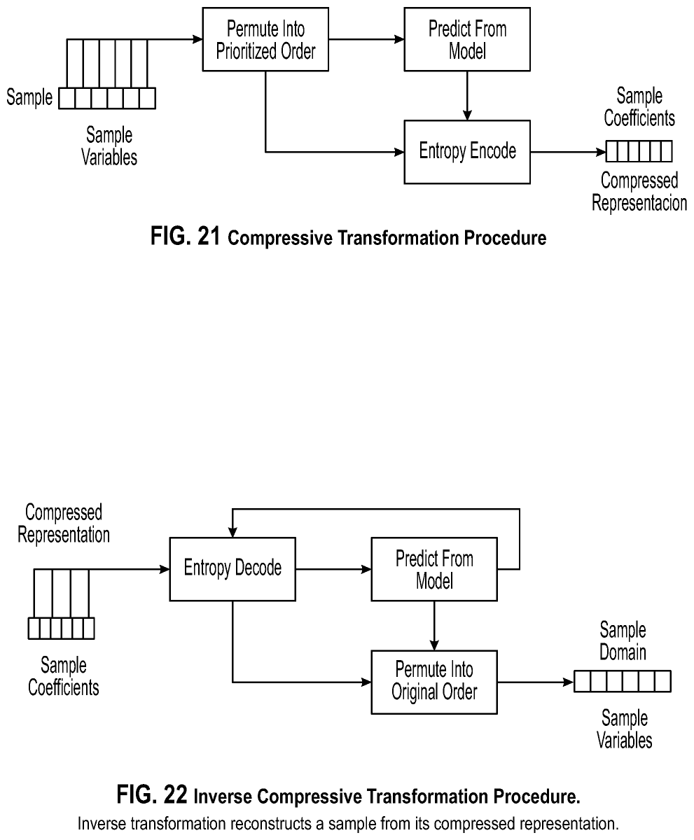

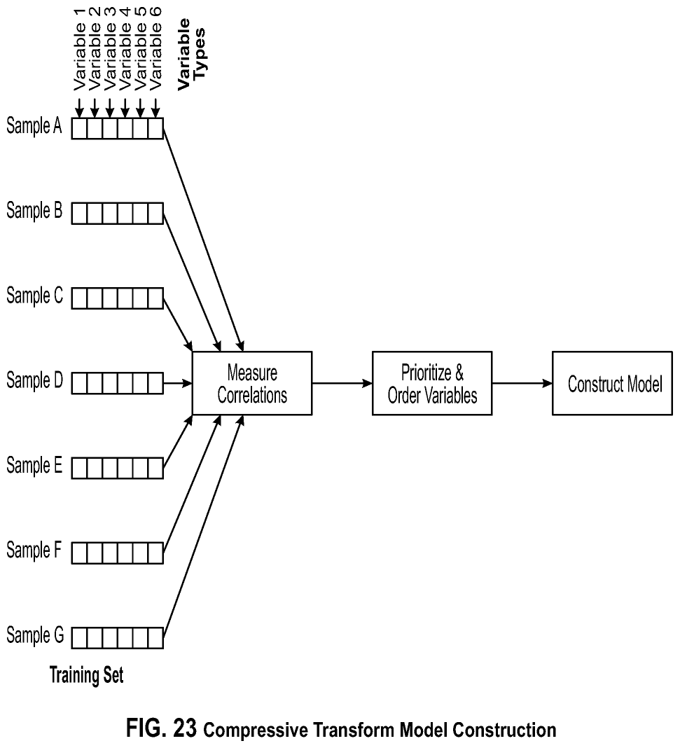

Presented are transformation methods that learn from possibly nonhomogeneous samples of discrete, random variables and derive a sequential arrangement of those variables from which a sequential predictor and entropy encoder can compress samples of such data into a sparser representation. In general, a process that involves organizing the contents of sample data (e.g., permutation) is called in some prioritized fashion, learning correlations between the contents of sample data, learning one or more models of the contents' values based upon their correlations and ordering, and entropy encoding a sample's contents based on predictions from the model or models compressive transformation (FIG. 21). Inverse compressive transformation is the general process of reversing compressive transformation to reconstruct an original sample from its compressed representation (FIG. 22). A variety of model types can be used for compression. However, a general model for compressive transformation should incorporate at least some sequential prioritization of information to compress based on correlations between the random variables that constitute a sample as measured from one or more sets of training samples (FIG. 23).

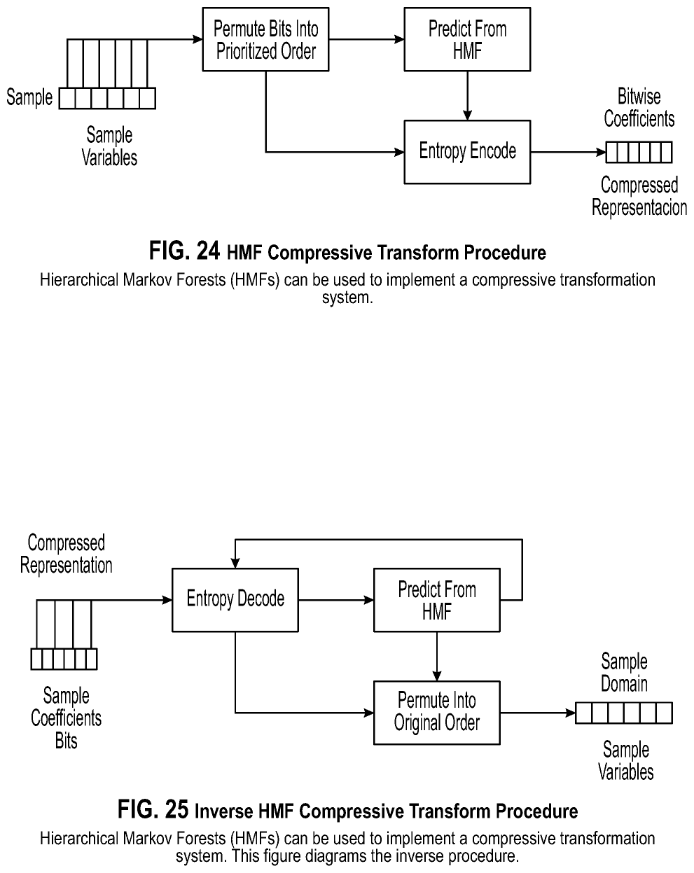

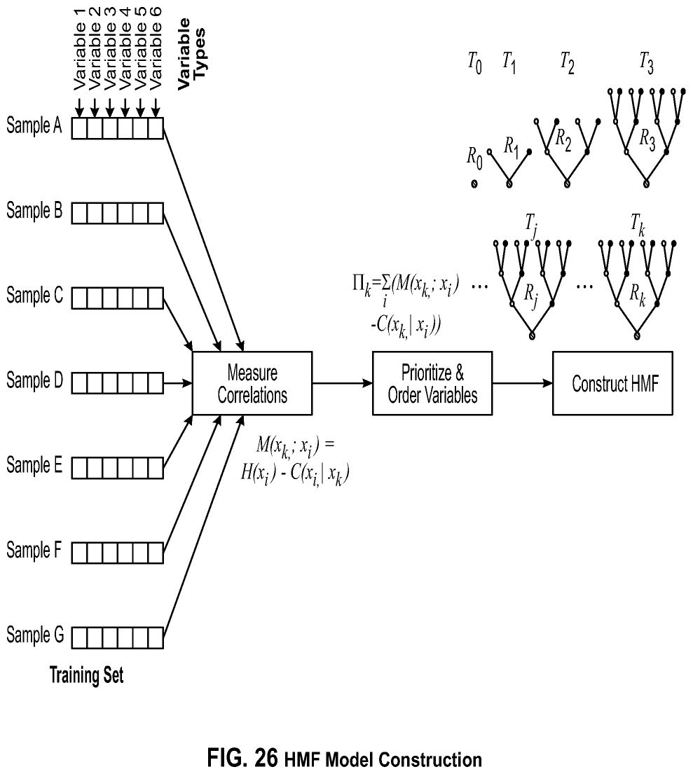

Hierarchical Markov Forest (or HMF) models can be used for compressive transformation, although these models are not exclusively applicable to compressive transformation and compressive transformation does not require use of HMFs. An HMF can be constructed with a method in which samples of categorical data are organized (or reorganized) in such a way that appropriate variable order Markov models (VMMs) constituting HMF and entropy encoders can compress them very well. FIG. 24 and FIG. 25 outline HMF forward and inverse transformations of a sample and its compressed coefficients, respectively, and FIG. 26 depicts an HMF training strategy to be elucidated further below.

Several illustrative systems are provided for digital image processing using HMFs to model wavelet transform coefficients and facilitate multiresolution analyses that find various applications in denoising, enhancement, and superresolution. Using these features, one can construct an image compression system which utilizes both a wavelet transform and HMF compressive transforms to generate a small, progressive bitstream from which the HMF prediction can actually estimate missing or unencoded data. Media utilizing such estimation can be referred to as Generative Media in light of the fact that these estimations can generate superresolution and super quality data that is unavailable to a decoder through the denoising and enhancement features of the wavelet and HMF compressive transformations.

Described next is an HMF, an HMF construction method, and an associated compressive transform system that learns from a training set of discrete, random variables of possibly different types and derives a sequential arrangement of those variables from which one of a set of VMM predictors predict a subsequent variable type's value from previously processed variable values in the set.

An HMF is a collection of tree network graphs that each predict the distribution of values a specific variable in a sample is likely to take conditioned on the observation of the values of variables in the same sample that are higher in some hierarchical ordering. In some instances, each tree network graph can constitutes a VMM. For example, consider a list of samples where each of k random variables Xᵢ={xᵢ₌₀, xᵢ₌₁, xᵢ₌₂, . . . xᵢ₌ₖ₋₁} take on different values Xᵢ(t)={xᵢ₌₀(t), xᵢ₌₁(t), xᵢ₌₂(t), . . . xᵢ₌ₖ₋₁(t)} at some time step t that defines a sequence of samples. The goal of an HMF construction system is to create a forest structure F consisting of k context trees Tⱼ that each model one of the variables in an order specified by the index j that designates the hierarchical ordering. To simplify the forthcoming notation, one can re-index X based on this hierarchical ordering into Xⱼ(t)={xⱼ₌₀(t), xⱼ₌₁(t), xⱼ₌₂(t), . . . xⱼ₌ₖ₋₁(t)}, which is a permutation Xᵢ. Mathematically, the forest structure can be represented as:

F={Tⱼ₌₀(t), Tⱼ₌₁(t), Tⱼ₌₂(t), . . . Tⱼ₌ₖ₋₁(t)}. (3)

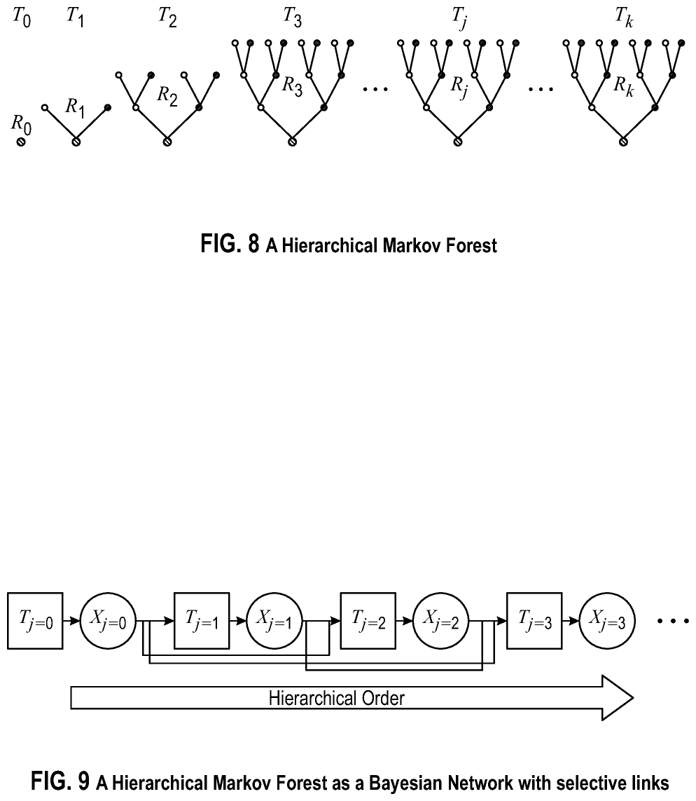

Each tree Tⱼ is a VMM for variable xⱼ with a context defined from variables x₀ to xⱼ₋₁. Rⱼ={x₀, . . . xⱼ₋₁} can be defined as a subset Xⱼ that contains relevant variables of causal index less than j comprising the tree model Tⱼ. A constituent variable of Rⱼ can be used to refer to x_{<j} to emphasize that its index must be less than j. The permutation of Xᵢ into the hierarchical ordering Xⱼ is to enforce a causal ordering of the variables, such that each tree Tⱼ is a suitable model for xⱼ given all previously traversable variables Rⱼ. FIG. 8 and FIG. 9 provide alternate depictions of an HMF.

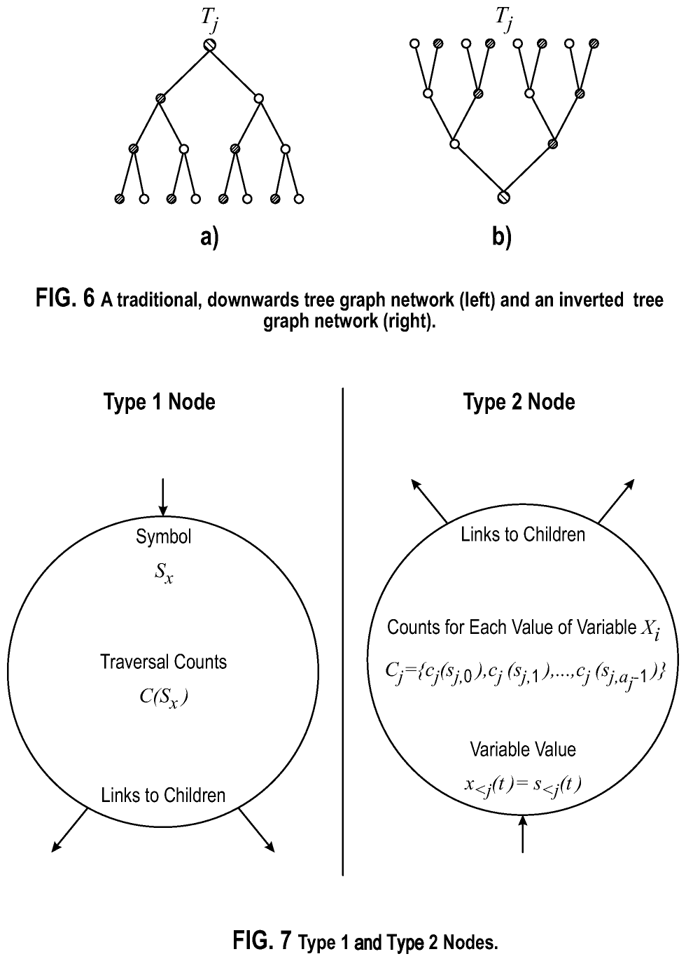

Consider tree networks akin to the traditional downwardly drawn example and inverted as depicted in FIG. 6. There is no theoretical difference between the two. However, the former can be used to describe sequential data—that is data from the same alphabet for which parent nodes predict future behavior from their child nodes. The latter can be used to describe correlated data—that is data from different random variables which might be related in some way. For example, one can use VMMs drawn as the first type of tree to predict a next node from a present node, which happens to correspond to the next, possible observation in a sequence. This type of tree is used to implement Prediction by Partial Matching (PPM) prediction algorithms. This type of tree can be referred to as a Type 1 Tree with Type 1 Nodes, as illustrated on the left side of FIG. 7.

The VMM trees including HMFs, however, contain nodes that correspond to a particular value of a particular variable type. All of these nodes predict the distribution of the possible values a variable type of interest (xⱼ) might take in a particular sample. In the language describing Context Tree Weighting (CTW) algorithms, context trees containing such nodes are often called tree sources, and these are the actual tree structures with which true CTW algorithms model observed data. One can refer to this type of tree as a Type 2 Tree (FIG. 6, right) consisting of Type 2 Nodes (FIG. 7, right), and draw it in an inverted tree structure to differentiate it from Type 1 Trees and Nodes.

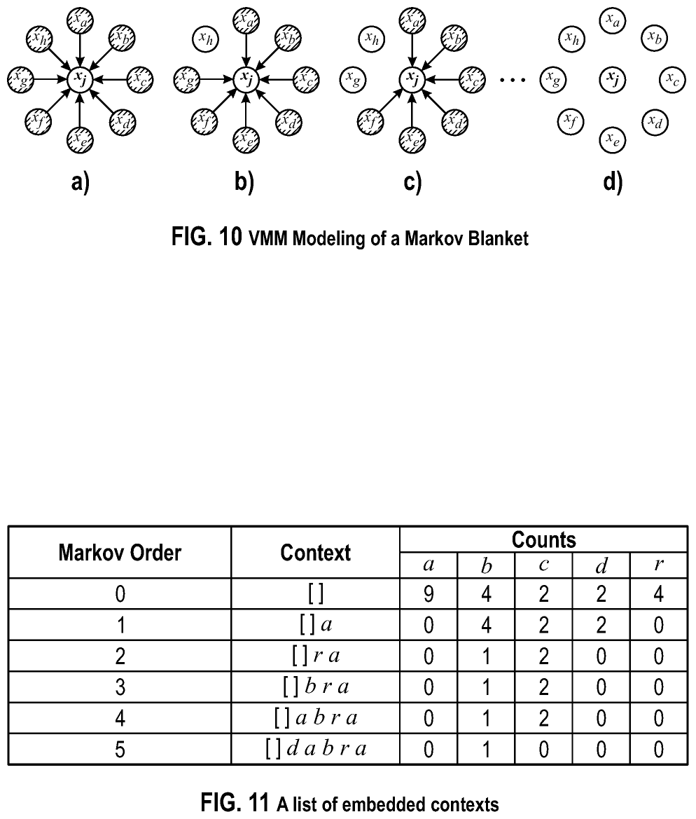

A summary of the construction steps for an HMF follow:
1. Measure informational correlations between variables Xⱼ.
2. Determine hierarchical ordering of variables Xⱼ.
3. For each variable xⱼ, define a list Rⱼ of the most correlated variables higher up the hierarchy. Each list constitutes a Markov Blanket (see FIG. 10) with respect to its variable type in the Bayesian Network that constitutes the HMF.
4. Train a Type 2 context tree T. for each variable xⱼ using training samples from Rⱼ.

In one embodiment a priority value can be assigned to a variable that is equal to the total information it provides about other variable types in question (possibly measured by total, pairwise, mutual entropy between the former variable type and the latter variable types) minus the total information provided by variable types to the initial variable type in question (possibly measured by total, pairwise, conditional entropy of the latter variable type given the former variable type). For example, the pairwise mutual entropy relations between variables xₖ and xₗ are:

$$\begin{matrix}M ( {x}_{k} ; {x}_{l} ) = M ( {x}_{k} ; {x}_{l} ) \\ = H ( {x}_{k} ) - C ( {x}_{k} \vert {x}_{l} ) \\ = H ( {x}_{l} ) - C ( {x}_{l} \vert {x}_{k} )\end{matrix} \qquad ( 4 )$$

where M(a; b) is the mutual entropy (e.g., the shared information) between two random variables, H(a) is the IID entropy of a random variable, and C(a|b) is the conditional entropy (e.g., the average amount of information) of variable a after observing a value of variable b . The conditional entropy C(a|b) is therefore equivalent to the optimal compression rate of variable a conditioned on variableb , and the mutual entropy M(a; b) is a measure of informational correlation. If the goal is to maximize compression of a series of samples of random variables through elucidation of conditional dependencies, then one should sort a variable type xₖ to compress in each sample by the total amount of compression it offers the remaining variable types, Mₜₒₜₐₗ(xₖ; xₗ), minus the cost Cₜₒₜₐₗ(xₖ|xₗ) of using the other remaining variable types to compress xₖ. Then, the priority Πₖ for each variable type provided all other variable types is

$$\begin{matrix}{Π}_{k} = {M}_{total} ( {x}_{k} ; {x}_{l} ) - {C}_{total} ( {x}_{k} \vert {x}_{l} ) \\ = {\sum }_{l} M ( {x}_{k} ; {x}_{l} ) - {\sum }_{l} C ( {x}_{k} \vert {x}_{l} ) \\ = {\sum }_{l} ( M ( {x}_{k} ; {x}_{l} ) - C ( {x}_{k} \vert {x}_{l} ) )\end{matrix} \qquad ( 5 )$$

To achieve better ordering, one can remove variable types from consideration in future computations involving Equation (5) once they have already been placed properly in the priority list. Other measures of correlation and priority are possible, including those that take more than only pairwise relationships into account. The hierarchical ordering then corresponds to the ordering of variable types by decreasing priority value. A person or device might also repeat the above process recursively or after one or more variable types is placed in hierarchical order—effectively re-sorting the order of each remaining variable type once a variable type has been specified a hierarchical index j.

In another embodiment, a priority value is assigned to a variable that is equal to the total information it provides about other variable types in question (possibly measured by total, pairwise, mutual entropy between the former variable type and the latter variable types) divided by the total the total information provided by variable types to the initial variable type in question (possibly measured by total, pairwise, conditional entropy of the latter variable type given the former variable type). The hierarchical ordering then corresponds to the ordering of variable types by decreasing priority value. A person or device might also repeat the above process recursively or after one or more variable types is placed in hierarchical order—effectively re-sorting the order of each remaining variable type once a variable type has been specified a hierarchical index j. Other priority measures exist that can be used to order variable types hierarchically using the appropriate information and (or) entropy correlations and mathematical relationships.

Various embodiments of the listing stage (3) select a small number of other variable types that are most correlated (possibly measured by mutual or conditional entropy) to each variable type. Small lists are recommended to mitigate tree construction complexities in stage (4) and complexities associated with compressive transformation. However, any number of correlated variable types can be selected per variable type, with the only restriction that the lists of correlated variable types must come from higher (e.g., with greater hierarchical priority) than a variable in question. One method of finding a suitable list Rⱼ to variable Xⱼ is to assign each possible member of Rⱼ a correlation rating that is the amount of information it provides about Xⱼ (possibly measured by mutual or conditional entropy) minus the total amount of information between it and other members of Rⱼ. Another possibility is to divide these informational quantities. Other measures of correlation rating exist. Similarly to the hierarchical ordering stage (2), a person or device might repeat the above process recursively or after one or more variable types is placed into Rⱼ until the correlation ratings of remaining variable types to add to the list fall below some threshold.

Embodiments of the tree construction system (4) build a Type 2 tree for each Xⱼ by linking sequences of nodes from the root of the tree up (see FIGS. 6-8) per sample of variable values within a training set, with each node corresponding to a value of each member variable of Rⱼ provided from least to greatest correlation rating. For example, one might construct the tree as follows:

For each variable from training sample Rⱼ(t), do the following to update tree Tⱼ:
1. Activate the root node of Tⱼ (e.g., the bottom node in a Type 2 tree).
2. Observe the current value of the first (or next relevant) variable x_{<j}(t) in sample Rⱼ(t).
3. If an active node has a child node corresponding to the variable value x_{<j}(t), then activate this node and de-activate its parent node.
4. If an active node does not have a child node corresponding to the variable value x_{<j}(t), then create a new child node corresponding to this value and activate it while de-activating its parent node.
5. Repeat Steps 1-5 for each active node and each relevant variable in sample Rⱼ(t).
6. For each remaining active node (including the root node), increment the count that corresponds to the current, observed value of xⱼ(t).
7. De-activate all nodes.

One of many advantages of the system is the use of the VMM tree to serve as an adaptively linking Markov Blanket to predict the value of variable xⱼ(t), as illustrated in FIG. 10. VMMs describe several variable lengths of Rⱼ that can form an instantaneous Markov Blanket for predicting xⱼ(t) because they allow variable length matches from observed data in samples to training data. Relative ordering of input variable values into the VMM tree is significant in determining the proper match of data. Also, because the performance of the VMM is sensitive to the ordering of the input data, the VMM should be constructed to order input variables from the least correlated to the most correlated with respect to the variable to be predicted. In this way, the most correlated variables can be most often matched to newly observed samples and can provide the best predictions for xⱼ(t). FIG. 9 presents the overall structure of the HMF as a hierarchical Bayesian Network with ever-changing links based on variable length, matched input data.

To predict a value for variable xⱼ(t) from a newly observed sample Xⱼ(t) at time t using its corresponding Type 2 tree Tⱼ and previously processed variables Rⱼ(t) in the sample:
1. Traverse the tree as in Steps 1-5 of the construction algorithm above, but drop any active nodes that do not have an appropriate child.
2. Predict the probability distribution over possible values of xⱼ(t) from the counts in remaining active nodes, which can be indexed with parameter m using a VMM prediction system (such a PPM, CTW, or other). Each active node together with its counts is a model (designated m) of variable xⱼ(t).

One embodiment of a compressive transform system is an entropy encoder that uses HMF predictions of variable values within a sample to compress the sample. Coefficients in the compressed representation consist of partitions of the compressed bitstream. Other embodiments of a compressive transform system consist of entropy encoders that utilize direct or indirect probabilistic modeling of sample variable values for compression. Embodiments of compressive transform systems can aggregate bits from a compressed representation into two or more partitions such that when each partition's bits are concatenated and interpreted as a numeric value, this value can be interpreted as the value of an aggregate coefficient.

One embodiment of an inverse compressive transform system is an entropy encoder that uses HMF predictions of variable values within a sample to decode/ decompress a compressed representation of a sample, returning the representation to the original sample domain. Other embodiments of an inverse compressive transform system consist of entropy decoders that utilize direct or indirect probabilistic modeling of sample variable values for decoding/ decompression. Embodiments of inverse compressive transform systems can divide bits from aggregate coefficient representations before decompression.

Various embodiments of VMM predictors can utilize tests of Markov relatedness between models m defined by the active nodes (or “contexts” in non-graphical representations of VMMs) in the process of generating a prediction. Such methods can be called “Embedded Context Fusion” or ECF. In addition, such methods generalize to network models other than VMMs, such as Markov chains and hidden Markov models.

One embodiment of ECF employs a Bayesian test of “embeddedness” to test the likelihood that one model's count distribution is drawn from the same probability distribution L (also called a “likelihood distribution”) as another model's count distribution. Such a test is also a test of Markov relatedness (e.g., statistical dependence on memory) in that a low probability of embeddedness implies that one model has a different, possibly relevant dependency on information contained within the memory of one model but not another. Therefore, a smaller probability of embeddedness of a higher-order model within a lower-order model implies that the higher-order model models dependency on memory information that is not available to the lower-order model, and is therefore more Markov related to (e.g., has a statistical dependency on) that information. As an example, for any set of active contexts simultaneously traversable within a VMM, the higher-order context count distributions Cₘ₊₁={c_{m+1,i}, i∈Z} are partitions of the lower-order count distributions Cₘ={c_{m,i}, i∈Z} in that c_{m+1,i}≤c_{m,i}, where the “order” is the number of nodes traversed from the root and where i indexes the possible values of a variable as a positive integer within the set Z . As an example, FIG. 11 presents a list of active contexts from active nodes in a VMM after processing the phrase abracadabrabracadabra. A Bayesian test of embeddedness between two models gives a probability that is equal to the area of the intersection between the likelihood functions implied by the count distributions of each model. In the case that the model counts imply a Dirichlet likelihood function Dir(L|Cₘ) (which is a probability distribution over all possible probability distributions that can generate a set of independent counts), the intersection can be mathematically described as:

$$\begin{matrix}p ( {L}_{m} = {L}_{m - 1} ) = {\int }_{L} Dir ( L \vert {C}_{m} ) ∩ Dir ( L \vert {C}_{m - 1} ) d L \\ = {\int }_{L} min ( Dir ( L \vert {C}_{m} ) , Dir ( L \vert {C}_{m - 1} ) ) d L\end{matrix} \qquad ( 6 )$$

The proper likelihood function for calculation of embeddedness depends on the nature of the process generating the counts and that the Dirichlet distribution is not the only option. Furthermore, approximation methods can be used in computation of the likelihood function intersection to mitigate potential computational complexities.

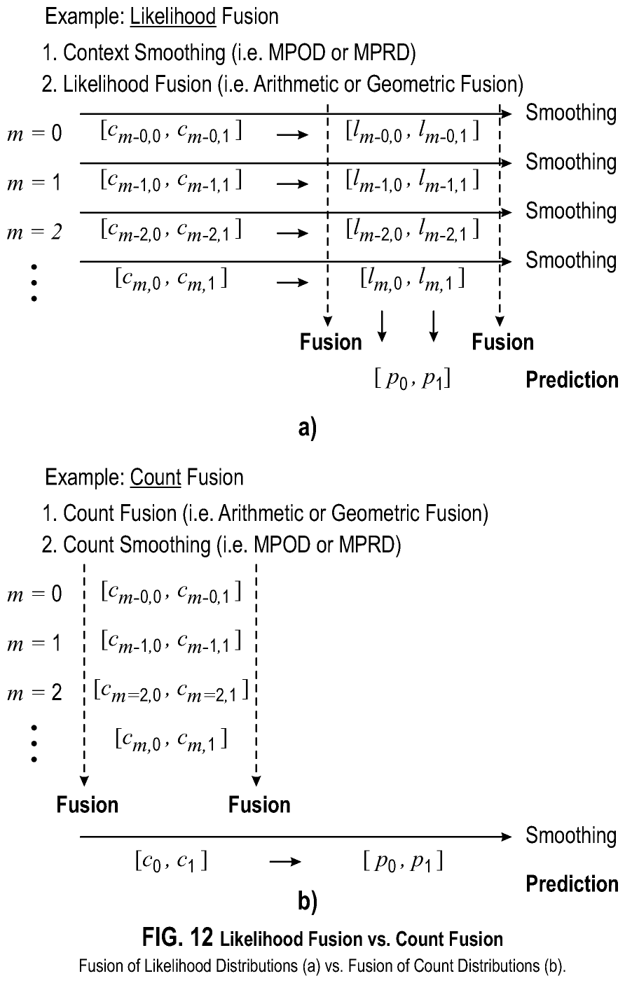

Another embodiment of ECF employs an exact test of embeddedness to measure Markov relatedness. For example, an exact test such as Fisher's or Bernard's Exact Test can be used to directly measure the likelihood that one set of counts is a random partition of another set of counts, which is the same as testing whether or not the two sets of counts are drawn from the same probability distributions. Similarly to the Bayesian methods above, one should choose the appropriate test for a given situation and can need to employ approximate methods to control computational complexities. Other embodiments of ECF might employ other test of embeddedness and/or Markov relatedness. One embodiment of ECF uses the probabilities of embeddedness as parameters for computing weights for fusing count distributions from a set of active node models. After combining count distributions, a smoothed and normalized distribution serves as the predicted probability distribution (See FIG. 12a.). Another embodiment of ECF uses the probabilities of embeddedness as weights for fusing likelihood distributions derived from the counts of a set of active node models. The combined likelihood distribution serves as the predicted probability distribution. An example is illustrated in FIG. 12b. One embodiment of ECF uses the probabilities of embeddedness directly as the weights for fusing count or likelihood distributions from a set of active node models.

Another embodiment of ECF uses the probabilities of embeddedness as proportions between the weights of available models. For example, the relative likelihood that a higher-order Markov model is better for prediction rather than an immediately lower-order Markov model is proportional to the likelihood that the higher-order distribution derives from a different probability distribution than the lower-order distribution. Consider the 1-Markov model case, where if the transition distributions are similar to the stationary distribution, then the process is more likely an IID process than a 1-Markov process. If the transition distributions are different than the stationary distribution, then a sequence likely obeys the 1-Markov process and a significant probability exists that the stationary and 1-Markov contexts are Markov-related. More clearly, comparing a higher-order model m to the immediately lower one m−1 is the same as the probability that the count distribution from m is a likely partition (e.g., is an embedment) of the count distribution from m−1:

wₘ∝p(Lₘ≠Lₘ₋₁)=(1−p(Lₘ=Lₘ₋₁)) (7)

Then, beginning from the highest order available model m and ending with model m−n, the relative weights form a recursive structure for computing all the weights:

$$\begin{matrix}{w}_{m} ∝ p ( {L}_{m} \neq {L}_{m - 1} ) \\ {w}_{m - 1} ∝ p ( {L}_{m - 1} \neq {L}_{m - 2} ) p ( {L}_{m} = {L}_{m - 1} ) \\ {w}_{m - 2} ∝ p ( {L}_{m - 2} \neq {L}_{m - 3} ) p ( {L}_{m} = {L}_{m - 1} ) p ( {L}_{m - 1} = {L}_{m - 2} ) \\ {w}_{m - n} ∝ p ( {L}_{m - n} \neq {L}_{m - n - 1} ) {\prod }_{i = n + 1}^{m} p ( {L}_{i} \neq {L}_{i - 1} )\end{matrix} \qquad ( 8 )$$

Other variations of approximations to Equations (7) and (8) are possible. Other embodiments of ECF select the model with largest weight for prediction.

Other embodiments of ECF select a single model for prediction that a set of heuristics estimates to have the largest weight. For example, a computational system might select a higher-order model with at least one or more positive counts of one or more values from training data, then continue to search for lower-order model with more total counts from training data that maintains the counts of zero-count values at zero until it finds the lowest-order model where the previous conditions are met. Embodiments of HMFs can use ECF for prediction. Embodiments of compressive transforms or inverse transforms can use ECF for prediction.

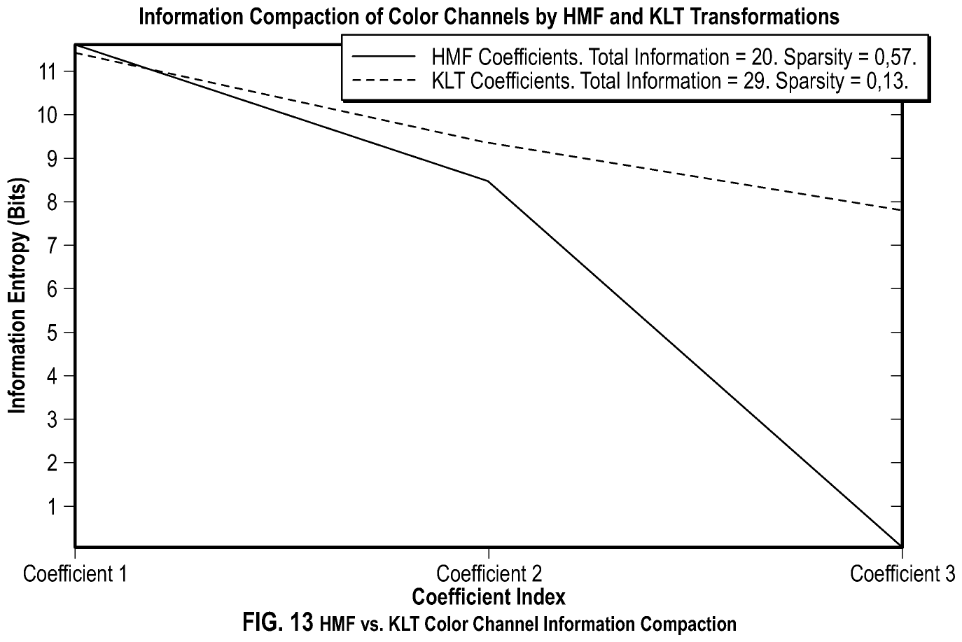

An embodiment of a compressive transform for decorrelating color channel information in single pixel samples of digital, color imagery learns an HMF description of every bit from every color channel per pixel sample. For example, a common bitmap image representation in the spatial domain includes a two dimensional array of pixels, each pixel comprising 8 bits of information for each of three color channels (red, green and blue—or equivalently RGB). The relevant HMF description to the present disclosure considers each color channel bit as a variable within single pixel samples. Therefore, this embodiment of an HMF includes 24 (e.g., 8 bits×3 color channels) VMMs arranged in a hierarchical fashion. Application of the HMF compressive transform to each sample yields a new representation in the compressed domain. Using an embodiment of a compressive transformation system that partitions bit-valued coefficients of the transform domain into two or more aggregate coefficients corresponding to a numerical interpretation of concatenated bits within each partition, a computational system can decorrelate RGB pixel data into three aggregate, compressed domain coefficients. FIG. 13 plots the empirical entropy of each aggregate coefficient after application of such an HMF compressive transformation on a digital, color image, where the entropy is computed from the distribution of an aggregate coefficient's values from each pixel sample. In this embodiment, each aggregate coefficient includes 12 bits. The HMF compressive transformation achieves better information compaction as measured by the Gini Coefficient than an integer KLT trained on the same image (plotted in FIG. 13), as is evidenced by the quicker decay of the coefficient entropy curve for the HMF compressive transform. This implementation of the KLT is implemented such that the possible range of coefficient values falls within the same 12 bit numerical representation as the aggregate HMF compressive transform's aggregate coefficients.

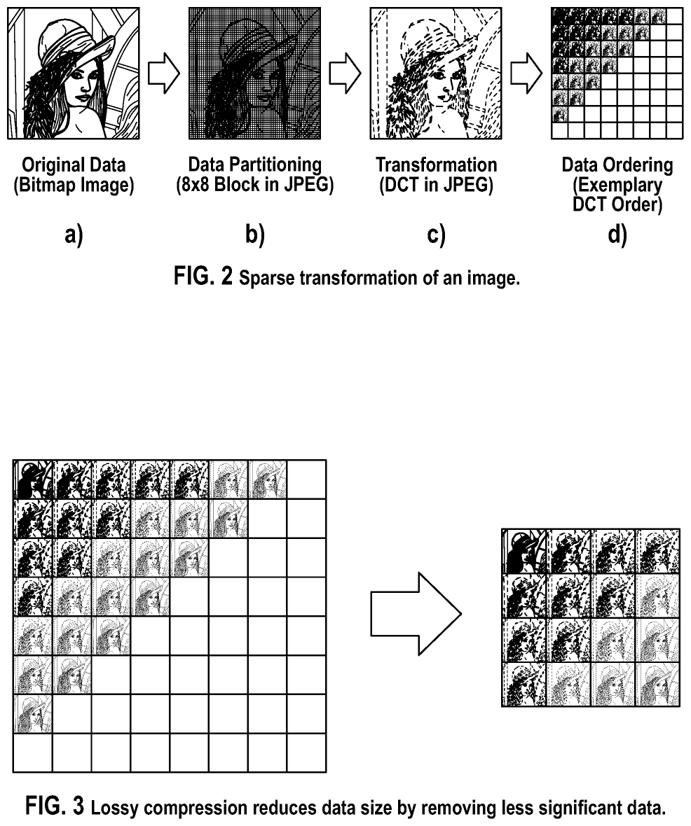

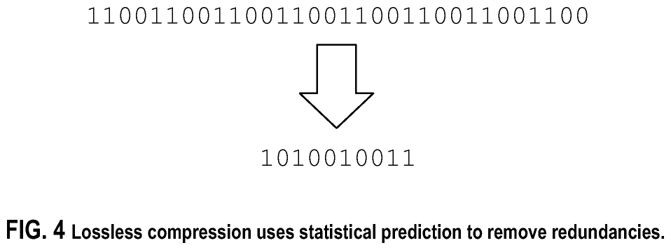

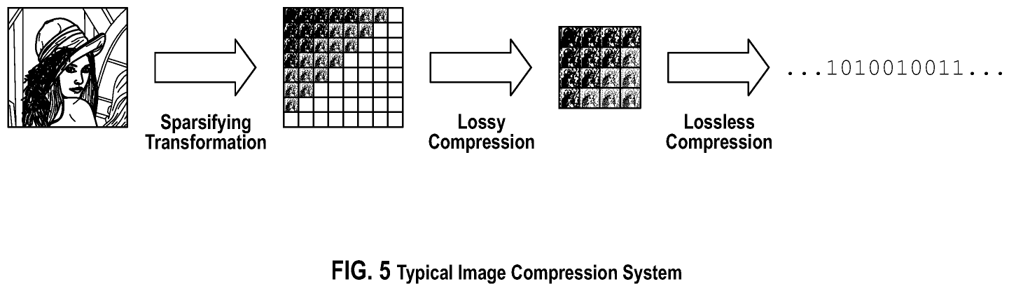

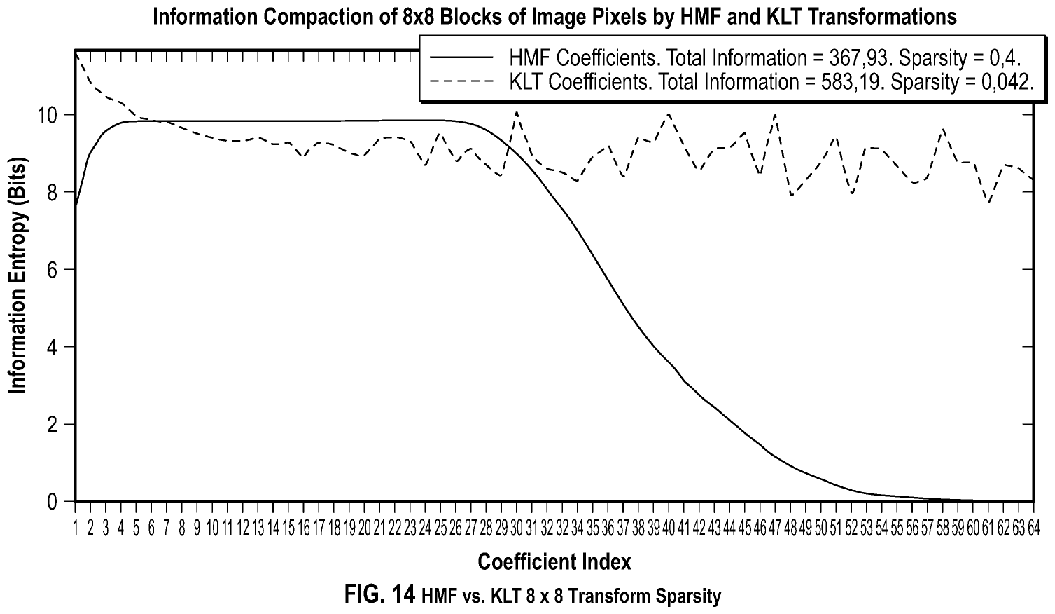

An embodiment of a compressive transform for decorrelating spatial information in regional samples of pixels in digital, grayscale imagery learns an HMF description for every bit of every pixel in a regional sample. Compressed transformation of such regions is analogous to the 8×8 regional decorrelation using the DCT as illustrated in FIG. 2, and this embodiment of the disclosure can serve the same applications as traditional, regional, block transforms like the DCT of FIG. 2. For example, a common, grayscale bitmap image representation in the spatial domain includes a two dimensional array of pixels, each pixel comprising 8 bits of light intensity information. The relevant HMF description to the present embodiment of disclosure considers each of the 8 bits in per pixel in an 8×8 region of pixels as a variable within a single sample, modeling a total of 512 (8 bits×8 pixels×8 pixels) variables, with the HMF consisting of 512 VMMs arranged in a hierarchical fashion. Application of the HMF compressive transform to each sample yields a new representation in the compressed domain. Using an embodiment of a compressive transformation system that partitions bit-valued coefficients of the transform domain into two or more aggregate coefficients corresponding to a numerical interpretation of concatenated bits within each partition, a computational system can decorrelate the spatial data into 64 aggregate, compressed domain coefficients to match the original 64 pixels per 8×8 region. FIG. 14 plots the empirical entropy of each aggregate coefficient after application of such an HMF compressive transformation on a digital, grayscale image, where the entropy is computed from the distribution of an aggregate coefficient's values from each regional sample. In this embodiment, each aggregate coefficient includes 12 bits. The HMF compressive transformation achieves better information compaction as measured by the Gini Coefficient than an integer KLT trained on the same image (plotted in FIG. 14), as is evidenced by the quicker decay of the coefficient entropy curve for the HMF compressive transform. This implementation of the KLT is implemented such that the possible range of coefficient values falls within the same 12 bit numerical representation as the aggregate HMF compressive transform's aggregate coefficients.

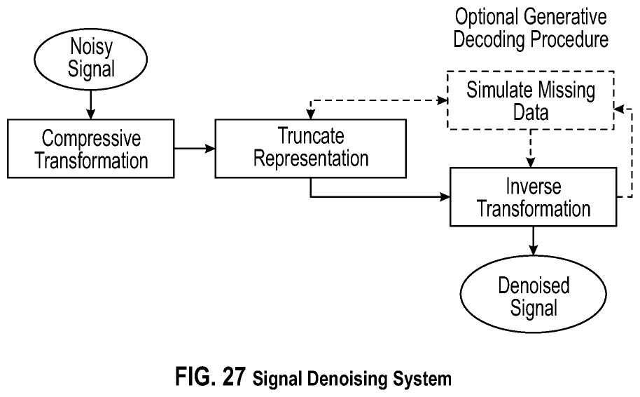

An embodiment of a system for signal denoising utilizes a truncation of a compressed transform representation followed by inverse compressive transformation (FIG. 27). Such an embodiment of a system for signal denoising can replace or modify at least a portion of a compressed transform representation with simulated data followed by or in tandem with inverse compressive transformation (FIG. 27). One embodiment uses the compressive transformation model (e.g., an HMF) to generate the simulated data. The combination with inverse transformation can be referred to as a generative decoding or generative denoising of the signal.

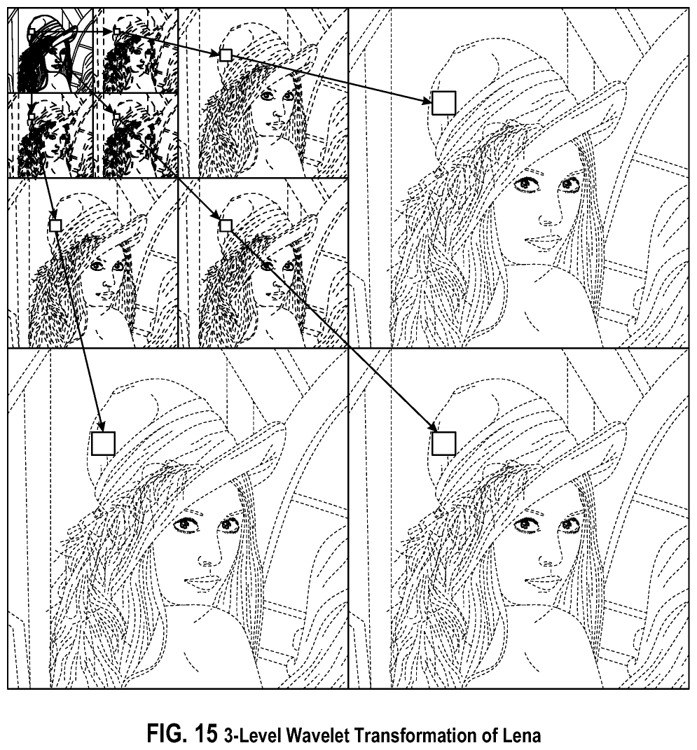

An embodiment of a system for image denoising utilizes a wavelet transform but with filtering performed in a compressed transform domain on localized wavelet coefficients. Such a system follows FIG. 27 generally, but with additional wavelet and inverse wavelet steps before and after the forward and inverse compressive transformation, respectively. An HMF compressed transformation should be useful for denoising and other applications in non-wavelet systems, as well. Noise is apparent in the form of unexpected data values when typically predictable data values are expected. Useful data sets have the quality that an intelligent agent can discern—or at least estimate—“true” values of data even in the presence of noise. Consider the case of scanned photographs, where wrinkles in the original image, scan lines, or particles of dust corrupt the scanned representation. If the scan is of any quality at all, then it should contain a reasonable approximation of imagery detailed within an original photograph. Wavelet transforms have the property that they divide data into complementary lowpass and highpass coefficients. Lowpass wavelet coefficients are a downsampled version of predictable data and highpass coefficients are a downsampled version of unpredictable data such as textures, lines, and noise. Thus, lowpass coefficients represent a somewhat “denoised” version of the original data (albeit at a lower resolution). Multiple applications of a wavelet transform result in a multiresolution analysis as illustrated in FIG. 15. This multiresolution property is a feature of wavelet transforms that are attractive tools in denoising applications. The general denoising process using wavelet transforms includes transforming a signal until the system obtains a reasonably denoised, lowpass set of approximation coefficients. Then, the system must attempt to distinguish between highpass coefficients containing real signal structure (e.g., textures and lines in image data) from the unwanted noise. By filtering highpass coefficients containing noisy data, the system can obtain a denoised version of the signal of interest through inverse transformation of the filtered coefficients. An embodiment of the disclosure as a denoising system applies a general wavelet denoising framework to a scanned, grayscale image by first decomposing the image using a wavelet transform, then training an HMF on select quadtrees of resulting coefficients.

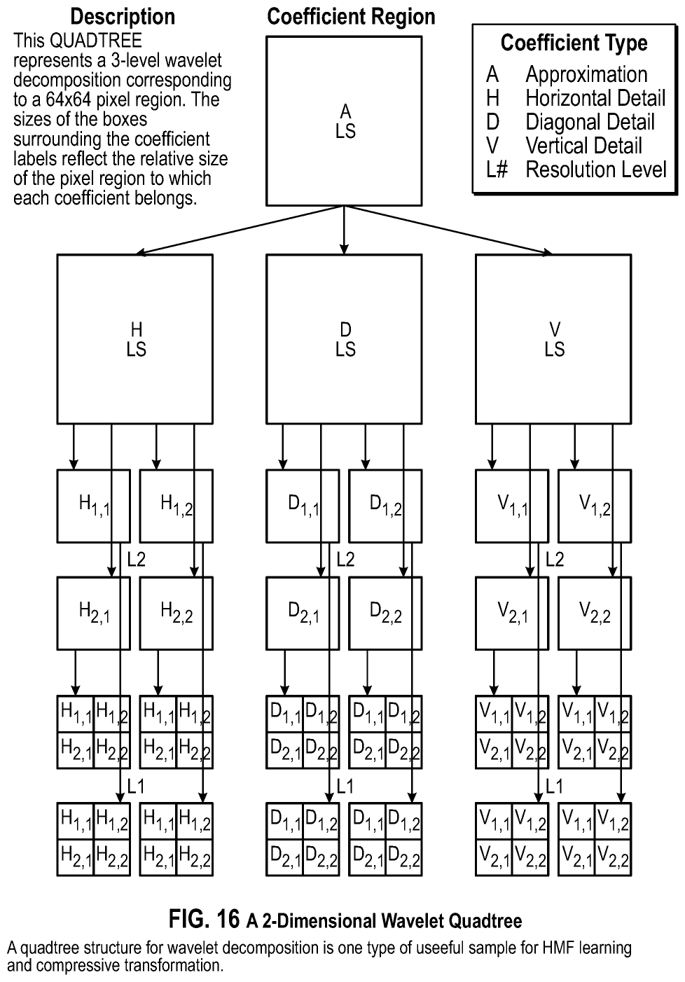

FIG. 15 and FIG. 16 illustrate possible quadtrees of wavelet coefficients. Each relevant sample includes the bits describing a quadtree of wavelet coefficients. The denoising system then attempts to smooth image features by removing unpredictable information within the HMF compressive transform domain. The simplest embodiment of such a system applies HMF training and compressive transformation to the bits of the simplest quadtrees of wavelet coefficients, which consist of a single approximation coefficient and its respective horizontal, vertical, and diagonal highpass coefficients (e.g., the top three coefficients types in the quadtree illustrated in FIG. 16). To ensure that the HMF models denoised data as well as possible while at the same time training on the most significant structural elements of the image, the HMF trains on the coefficients representing a 128×128 scale approximation of the image, which is about the size of a thumbnail.

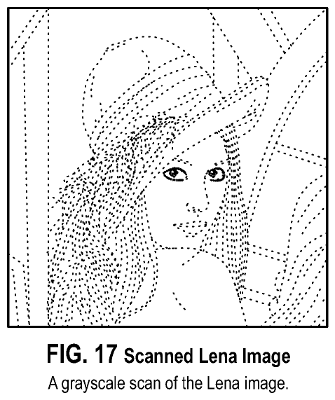

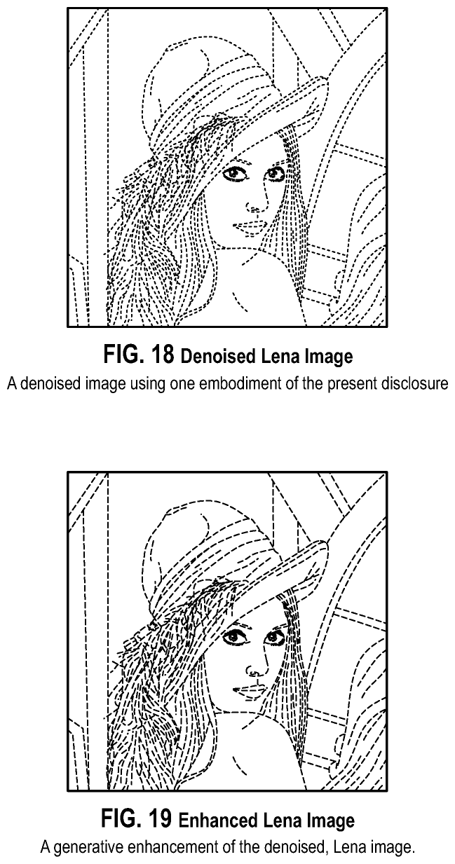

This small scale also allows relatively fast training of the HMF, because it does not contain a large number of data. HMF compressive transformation is applied to the highpass coefficients of the largest scale, using observed lowpass coefficient bits at that scale and previously parsed highpass coefficient bits in the quadtree. The lowpass coefficients at this scale represent a slightly lower resolution, but denoised version of the full image. The initial coefficient bits of the compressive transformed highpass coefficients contain relevant structural data. The latter bits of the compressive transformed highpass coefficients likely contain the noisy elements of the image. Of particular importance to the denoising method is the way in which the transform encodes the coefficient bits using an arithmetic encoder. Specifically, the arrangement of the probabilistic representation in the encoder at every step such that the most likely symbol to encode is always nearest to the bottom of the range. By this fashion, the encoder favors coding more likely sequences to zero-valued coefficients, although similar systems could equally set the most likely bits to the top of the range, thus favoring one-valued coefficients. By setting noisy, highpass compressed transform coefficient bits to zero, this embodiment of the system ensures inverse compressive transformation will result in a more likely sequence of coefficient data, and thus can be considered a greedy maximum likelihood system for image denoising. This method is greedy by the fact that it only decodes the most likely coefficient bit at every step individually and does not select the complete group of coefficient bits that would be the most likely collectively. One might construct a system that tracks the probability of all possible combinations of coefficient bits and selects the most likely combination using the Viterbi, MAP, or another path optimizing algorithm. FIG. 17 and FIG. 18 display a noisy scan of the original Lena image and an image denoised by this embodiment of the system, respectively.

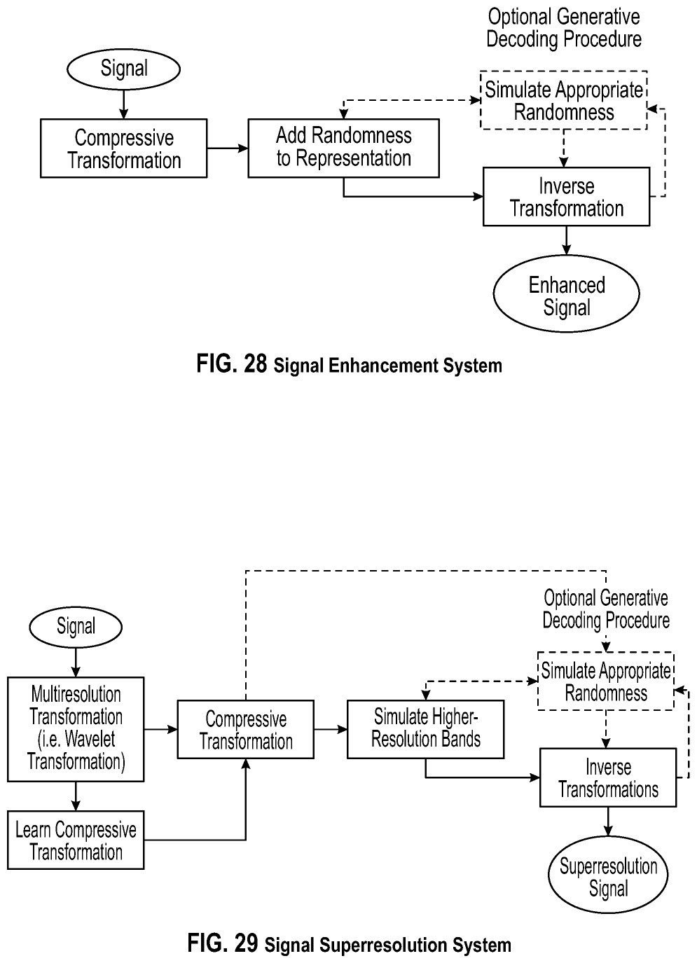

An embodiment of a system for signal enhancement utilizes a randomization of at least a portion of compressed transform representation followed by inverse compressive transformation (FIG. 28). An embodiment of a system for signal enhancement replaces or randomizes at least a portion of a compressed transform representation with simulated data followed by or in tandem with inverse compressive transformation (FIG. 28). One embodiment uses the compressive transformation model (e.g., an HMF) to generate the simulated data. The combination with inverse transformation can be referred to as a generative decoding or generative enhancement of the signal.

An embodiment of the disclosure for image enhancement that utilizes a wavelet transform, but with filtering performed in a compressed transform domain on localized wavelet coefficients adds detail into an image. Such a system follows FIG. 28 generally, but with additional wavelet and inverse wavelet steps before and after forward and inverse compressive transformation, respectively. The embodiment presented here is somewhat simplistic for explanatory purposes. An HMF compressed transformation should be useful for enhancement and other applications in non-wavelet and non-visual systems, as well. The system is constructed as the denoising system above, but instead of replacing highpass coefficients with zero-valued bits, the enhancement system replaces them with randomly valued (0 or 1) bits. Inverse compressed transformation then results in a simulation of detail based on the predictive statistics contained within the HMF. By controlling the distribution or location of random bits, one can control the amount or location of the enhancement. This process can be referred to as a “generative” decoding because it generates missing data (e.g., the altered highpass bits) through randomized simulation. FIG. 19 is an illustration of enhancement using generative decoding of completely random bits by the system on the denoised image of FIG. 18.

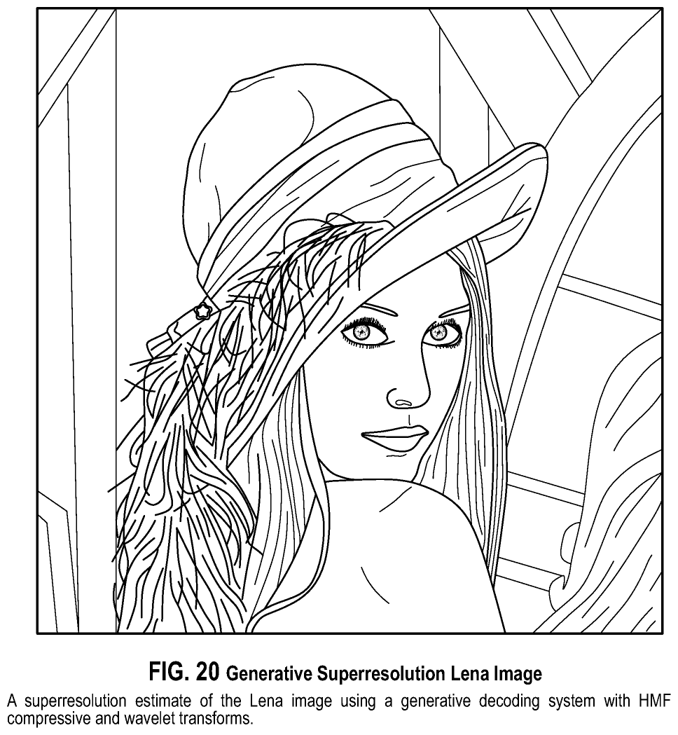

An embodiment of the system produces a superresolution (e.g., larger size) version of a digital image without the use of outside information. The embodiment presented here (depicted in FIG. 29) is somewhat simplistic for explanatory purposes. An HMF compressed transformation should be useful for superresolution and other applications in non-wavelet and non-visual systems, as well. The system is constructed as the enhancement system above, but instead of replacing highpass coefficients with randomly-valued bits, the enhancement system adds another level of compressed domain, highpass coefficient data, effectively allowing inverse wavelet compressed transformation followed by inverse wavelet transformation up to a higher resolution (at double the scale in each dimension for typical implementations of wavelets that subsample by a factor of 2 in each dimension). By controlling the statistics and possibly location of the bits comprising the higher level compressed transform coefficients, one can control the amount and (or) location of the enhancement. This process can be referred to as a “generative” decoding because it generates missing data (e.g., the altered highpass bits) through randomized simulation. FIG. 20 is an illustration of superresolution using generative decoding of completely random bits by the system on the scanned Lena image of FIG. 17.

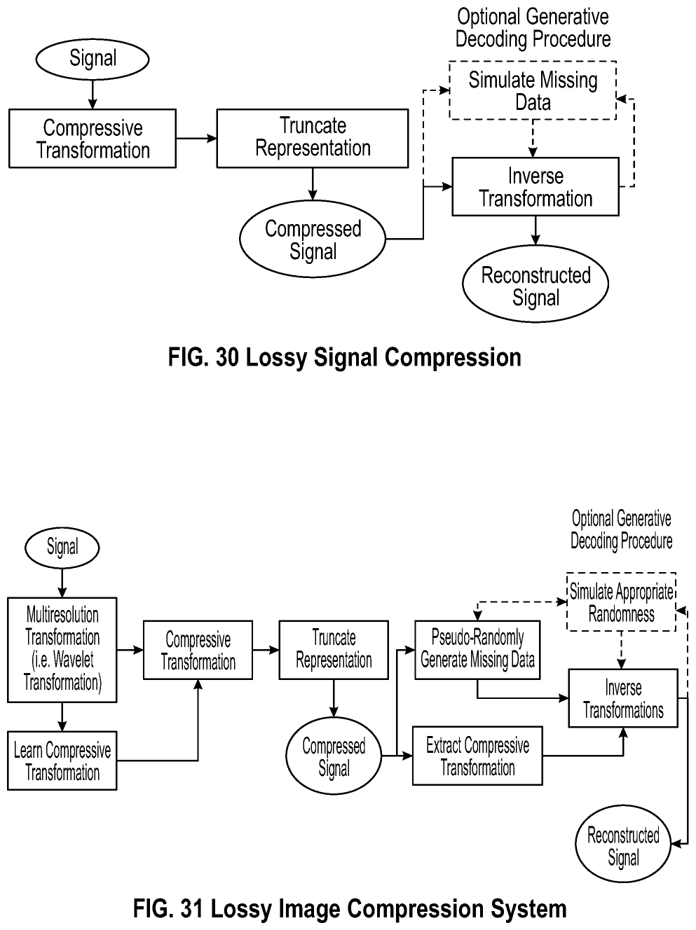

An embodiment of the system performs digital image compression and decompression in both lossless and lossy modes. The encoding portion of the compression system is constructed similarly to the denoising and enhancement systems above in the it learns an HMF from simple coefficient quadtrees at lower scales then uses the HMF to compressively transform the highpass coefficients at a larger scale. In general, these quadtrees might include more than one level of scale information and bits from multiple color channels as variables. Successive training of the HMF from the lowest scale to the highest scale results in more and more effective compressive transformation from an information compaction standpoint and ultimately leads to better and better compression. Lossy compression is obtained by encoding or sending only a portion of the quadtree information (e.g., only the lower scale information), and lossless compression is obtained by encoding all quadtree information. Decompression can be performed directly or generatively using either or both simulated coefficients not present within the lossy representation and simulated pixel data from randomized control of the compressive transform model inputs and outputs. FIG. 30 depicts both forward compression and decompression for a general signal, and FIG. 31 depicts an embodiment of the more specific image compression and decompression system described above.

An embodiment of the image compression system forms a progressive bitstream that is scalable in quality by further encoding like-coefficients from multiple quadtree samples in the compressed domain, from most significant coefficient to least significant. An embodiment of the image compression system forms a progressive bitstream that is scalable in resolution by further encoding highpass, quadtree samples from the lowest wavelet resolution to the highest. Lossy embodiments of the image compression system encode a progressive bitstream until a target file size is met.

Embodiments of the decoding stage of the image compression system decode available portions of a lossy encoding, and simulate missing compressed transform data generatively, as in the enhancement or superresolution systems described above, by inserting random, semi-random, or non-random compressed transform coefficients that have yet to be decoded or are unavailable at the time of decoding. By controlling the statistics and possibly location of the bits representing the transform coefficients, one can control the amount or location of the generative decoding.

Embodiments of a subset or all (and portions or all) of the above can be implemented by program instructions stored in a non-transitory computer readable medium or a transitory carrier medium and executed by a processor. The non-transitory computer readable medium can include any of various types of memory devices or storage devices. For example, the non-transitory computer readable medium can include optical storage media, such as a Compact Disc Read Only Memory (CD-ROM), a digital video disc read only memory (DVD-ROM), a BLU-RAY® Disc Read Only Memory (BD-ROM), and writeable or rewriteable variants such as Compact Disc Recordable (CD-R), Compact Disc Rewritable (CD-RW), Digital Video Disc Dash Recordable (DVD-R), Digital Video Disc Plus Recordable (DVD+R), Digital Video Disc Dash Rewritable (DVD-RW), Digital Video Disc Plus Rewritable (DVD+RW), Digital Video Disc Random Access Memory (DVD-RAM), BLU-RAY Disc Recordable (BD-R), and BLU-RAY Disc Recordable Erasable (BD-RE). As another example, the non-transitory computer readable medium can include computer memory, such as static random access memory (SRAM), dynamic random access memory (DRAM), high-bandwidth memory (HBM), non-volatile random access memory (NVRAM), read only memory (ROM), programmable read only memory (PROM), erasable programmable read-only memory (EPROM), electrically erasable programmable read only memory (EEPROM), NOR based flash memory, and NAND based flash memory. The non-transitory computer readable medium can also include various magnetic media, such as floppy discs, magnetic tapes, and hard discs.

In addition, the non-transitory computer readable medium can be located in a first computer in which programs are executed, or can be located in a second different computer that connects to the first computer over a network, such as the Internet. In the latter instance, the second computer can provide program instructions to the first computer for execution. The term “non-transitory computer readable medium” can also include two or more memory mediums that can reside in different locations, such as in different computers that are connected over a network. In some embodiments, a computer system at a respective participant location can include a non-transitory computer readable medium on which one or more computer programs or software components according to one embodiment can be stored. For example, the non-transitory computer readable medium can store one or more programs that are executable to perform the methods described herein. The non-transitory computer readable medium can also store operating system software, as well as other software for operation of the computer system.

The non-transitory computer readable medium can store a software program or programs operable to implement the various embodiments. The software program or programs can be implemented in various ways, including procedure-based techniques, component-based techniques, object-oriented techniques, functional programming techniques, or other approaches. For example, the software programs can be implemented using ActiveX controls, C++objects, JavaBeans, MICROSOFT® Foundation Classes (MFC), browser-based applications (e.g., Java applets or embedded scripts in web pages), or other technologies or methodologies. A processor executing code and data from the memory medium can include a means for creating and executing the software program or programs according to the embodiments described herein.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the various embodiments of the present disclosure. It is to be understood that the forms of the embodiments of the disclosure shown and described herein are to be taken as illustrative embodiments. Elements and materials can be substituted for those illustrated and described herein, parts and processes can be reversed, and certain features of the various embodiments of the present disclosure can be utilized independently. Changes can be made in the elements described herein without departing from the spirit and scope of the disclosure as described in the following clauses or claims.

1. A method, comprising:
computing likeness measures between discrete samples of data;
ordering data according to a priority value based at least in part on a portion of the likeness measures;
constructing one or more models based at least in part on a portion of the likeness measures and at least a portion of the ordered data; and
transforming, according to at least a portion of at least one of the models, by a computer system, samples of data into a progressive, binary representation comprising sets of single-bit coefficients.

2. The method of clause 1, wherein transformation of at least a portion of a data sample uses a compression system.

3. The method of clause 2, wherein the compression system uses a prediction about at least one partition of sample data to transform the sample data.

4. A method according to any one of clauses 1-3, wherein a plurality of the bit coefficients comprise block transform coefficients.

5. A method according to any one of clauses 1-4, wherein a plurality of the bit coefficients comprise multiresolution transform coefficients.

6. A method according to any one of clauses 1-5, wherein concatenation of bit coefficients constitutes a new set of coefficients.

7. A method according to any one of clauses 1-5 or 6, wherein transformation of a color channel representation of pixel data results in a new set of bit level color channels.

8. A method according to any one of clauses 1-7, wherein concatenations of sets of bit level color channels constitutes a new set of color channels.

9. A method according to any one of clauses 1-8, wherein transformation of a spatial region of pixel data from digital imagery decorrelates the spatial data.

10. A method according to any one of clauses 1-9, wherein transformation of a spatial region of pixel data from digital imagery decorrelates the spatial data at multiple resolutions.

11. A method according to any one of clauses 1-10, wherein transformation of a pixel color data from digital imagery decorrelates the color data.

12. A method according to any one of clauses 1-11, wherein transformation of samples of digital imagery containing both spatial and color data results in progressive representations of those samples, the progressive representation comprising information ordered at least approximately by most to least significant.

13. A method according to any one of clauses 1-12, wherein transformation of samples of digital imagery containing both spatial and color data decorrelates both the spatial and color data simultaneously.

14. A method according to any one of clauses 1-13, wherein alteration of bit coefficients constitutes the removal of noise or detail from data.

15. A method according to any one of clauses 1-14, wherein alteration of bit coefficients constitutes the removal of noise or detail from data.

16. A method according to any one of clauses 1-15, wherein alteration of bit coefficients constitutes the removal of noise or detail from data.

17. A method according to any one of clauses 1-16, wherein alteration of bit coefficients constitutes the removal of noise or detail from data.

18. A method according to any one of clauses 1-17, wherein removal or alteration of transform representations of samples of digital imagery containing both spatial and color data results in denoised imagery after inverse transformation.

19. A method according to any one of clauses 1-18, wherein alteration of bit coefficients constitutes the addition of noise or detail from data.

20. A method according to any one of clauses 1-19, wherein alteration of bit coefficients constitutes the addition of noise or detail from data.

21. A method according to any one of clauses 1-20, wherein alteration of bit coefficients constitutes the addition of noise or detail from data.

22. A method according to any one of clauses 1-21, wherein insertion of extra bit coefficients constitutes a higher resolution representation of data.

23. A method according to any one of clauses 1-22, wherein insertion or alteration of transform representations of samples of digital imagery containing both spatial and color data results in enhanced imagery after an inverse transformation.

24. A method according to any one of clauses 1-23, wherein the bit coefficients constitute a losslessly compressed representation of data.

25. A method according to any one of clauses 1-24, wherein truncation of less significant bit coefficients results in a lossy, compressed representation of data.

26. A method, comprising:
computing probabilities that the data in a plurality of models contain similar information;
fusing the information contained in a set of the models using the probabilities that the models are similar; and generating predictions about data using the fused information from the models.

27. The method of clause 26, wherein an entropy encoder utilizes the predictions from at least one of the plurality of models to compress data.

28. The method of clauses 26 or 27, wherein transformation constitutes the compression of data.

29. A system for predicting data that implements the method of clause 26, 27, or 28.

30. Systems for compressing, decompressing, storing, and transmitting data that implements the method of clause 26, 27, or 28.

31. The method of clauses 1-27, wherein correlations are measured by pairwise entropy.

32. The method of clause 1-27 or 31, wherein data ordering is prioritized by a relation between pairwise entropy measures.

33. The method of clauses 1-27, 31 or 32, wherein at least one variable order Markov model (VMM) models data.

34. The method of clauses 1-27 or 31-33, wherein at least one variable order Markov model (VMM) is constructed.

35. The method of clauses 1-27 or 31-34, wherein at least one variable order Markov model (VMM) is constructed using training data.

36. The method of clause 1-27 or 31-35, wherein at least one variable order Markov model (VMM) is constructed using correlations measured by pairwise entropy and training data.

37. The method of clause 1-27 or 31-36, wherein at least one hierarchical Markov forest (HMF) models data, the HMF comprising one or more variable order Markov model (VMM).

38. The method of clause 1-27 or 31-37, wherein at least one hierarchical Markov forest (HMF) and its constituent variable order Markov models (VMMs) are constructed wherein correlations are measured by pairwise entropy.

39. The method of clause 1-27 or 31-38, wherein at least one hierarchical Markov forest (HMF) and its constituent variable order Markov models (VMMs) are constructed when data ordering is prioritized by a relation between pairwise entropy measures.

40. The method of clause 1-27 or 31-39, wherein at least one hierarchical Markov forest (HMF) and its constituent variable order Markov models (VMMs) are constructed when data ordering is prioritized by a relation between pairwise entropy measures.

41. The method of clause 1-27 or 31-40, wherein computation of prediction probabilities utilizes a Dirichlet likelihood function.

42. The method of clause 1-27 or 31-41, wherein computation of prediction probabilities utilizes an approximation of a Dirichlet likelihood function.

43. The method of clause 1-27 or 31-42, wherein the result of the Dirichlet likelihood function is approximated using Bayesian testing.

44. The method of clause 1-27 or 31-43, wherein the result of the Dirichlet likelihood function is approximated using exact testing.

45. The method of clauses 1-27 or 31-44, wherein the result of the Dirichlet likelihood function is approximated by Fisher's exact test.

46. The method of clauses 1-27 or 31-45, wherein the result of the Dirichlet likelihood function is approximated by Barnard's exact test.

47. The method of clause 1-27 or 31-46, wherein the result of the Dirichlet likelihood function is used as a weight measuring a relative quality of each model within a set of active models.

48. The method of clause 1-27 or 31-47, wherein the result of the Dirichlet likelihood function is used is as parameters for computing weights measuring the relative quality of each model within a set of active models.

49. The method of clause 1-27 or 31-48, wherein model weights are computed according to a recursive structure for computing weights.

50. The method of clauses 1-27 or 31-49, wherein a fused likelihood distribution is computed through a weighted averaging of individual likelihoods derived from each model.

51. The method of clauses 1-27 or 31-50, wherein a fused likelihood distribution is computed through a weighted averaging of individual model count distributions.

52. The method of clauses 1-27 or 31-51, wherein a fused likelihood distribution is computed through a weighted averaging of individual likelihoods derived from each model according to a recursive structure for computing weights.

53. The method of clauses 1-27 or 31-52, wherein a fused likelihood distribution is computed through a weighted averaging of individual model count distributions from which the likelihood distribution is derived.

54. The method of clauses 26, 41 or 42, and 48, wherein a search is used to find a single model that best approximates a complete weighting and fusion of the models.

55. The method of clauses 26, 41, 42, 47, or 54, wherein a computational system searches for a model with at least one or more positive counts of one or more values from training data.

56. The method of clauses 26, 41, 42, 47, 54, or 55, further comprising continuing to search for a model with more total counts from training data that maintains the counts of zero-count values at zero continues after finding a model with at least one or more positive counts of one or more values from the training data.

57. A non-transitory computer-readable medium containing a program comprising:
code that computes likeness measures between discrete samples of data;
code that orders data according to a priority value based at least in part on a portion of the likeness measures;
code that constructs one or more models based at least in part on a portion of the likeness measures and at least a portion of the ordered data; and
code that transforms, according to at least a portion of at least one of the models, samples of data into a progressive, binary representation comprising sets of single-bit coefficients.

58. The non-transitory computer-readable medium of clause 57, wherein the code that transforms uses a compression system.

59. The method of clause 58, wherein the compression system uses predictions about at least one partition of sample data to transform the samples of data.

60. A system, comprising:
a computing device; and
an application executable in the computing device, the application comprising:
logic that computes likeness measures between discrete samples of data;
logic that orders data according to a priority value based at least in part on a portion of the likeness measures;
logic that constructs one or more models based at least in part on a portion of the likeness measures and at least a portion of the ordered data; and
logic that transforms, according to at least a portion of at least one of the models, samples of data into a progressive, binary representation comprising sets of single-bit coefficients.

61. The system of clause 60, wherein the logic that transforms uses a compression system.

62. The system of clause 60, wherein the compression system uses predictions about at least one partition of sample data to transform the samples of data.
